(19) United States
(12) Patent Application Publication
(10) Pub. No.: US 2002/0128940 A1
(43) Pub. Date: Sep. 12, 2002

(54) Methods and systems for electronically representing records of obligations

(76) Inventors: Steven Orrin, West Orange, NJ (US); Yitzchak Katz, Flushing, NY (US); David E. Boundy, New York, NY (US); David M. Klein, Woodmere, NY (US)

Correspondence Address: SHEARMAN & STERLING, INTELLECTUAL PROPERTY DOCKETING, 599 LEXINGTON AVENUE, NEW YORK, NY, 10022, US

(21) Appl. No.: 10/059,914

(22) Filed: Jan. 28, 2002

Related U.S. Application Data
(60) Provisional application No. 60/264,590, filed on Jan. 26, 2001.

(51) Int. Cl. G06F 17/60

(52) U.S. Cl. 705/35

(57) ABSTRACT

Methods and systems for electronically representing records of obligations are provided. The records are stored such that content describing an obligation from an obligor to an obligee is unalterable, identifiable as current and authentic, and non-repudiable. Transfers of ownership of the obligation may also be controlled and recorded using the electronic records. An obligation may not be recorded as being transferred without the consent of the of the current owner of the obligation. Security interests in obligations may also be recorded. The secured party may be able to control transfer of ownership of the obligations and modification of the electronic records. In preferred embodiments, these features may be achieved by using various digital signature and encryption techniques.

### CROSS REFERENCE TO RELATED APPLICATION

This application claims the benefit under 35 U.S.C. § 119(e) of U.S. Provisional Patent Application No. 60/264,590, filed Jan. 26, 2001 and entitled “ELECTRONIC REPRESENTATION OF OBLIGATIONS”, which is hereby incorporated by reference herein in its entirety.

### BACKGROUND

The invention relates to arrangements for automated financial or business practices.

Under various laws, the right to receive the benefit of certain obligations is dictated by control of legal documents memorializing that obligation. For example, with notes relating to certain loans, the right to receive payment under that note is dictated by control of the authoritative copy of that note.

For some of these types of legal documents, for instance stock certificates, commercial paper, etc., parties frequently have an interest in determining the authenticity and current ownership of a document. This determination may be made by determining whether a document is an authoritative copy of the legal document and whether a party of interest has control of the authoritative copy. For instance, a present owner of stock in a company may be assured of the release of any claim by a past owner of that stock when the present owner takes delivery of a corresponding authenticate stock certificate. Similarly, a lender may be assured that a borrower does in fact have right to use a piece of property as collateral for a loan by determining that the borrower has clean title to the property. Security interests in obligations embodied in documents have traditionally perfected when the secured party takes possession of the documents. Real estate recording systems have provided third parties with a reliable way to determine the contents of deeds conveying property from one party to another.

Changes to the laws governing the types of legal documents have allowed for electronic copies of legal documents to be used for the same purposes as their paper counterparts. For example, under Section 9-105 of the Uniform Commercial Code, as revised in 1999, a party is determined to have control of an electronic copy of a record of an obligation if the following requirements are met:

§ 9-105. Control of Electronic Chattel Paper.

A secured party has control of electronic chattel paper if the record or records comprising the chattel paper are created, stored and assigned in such a manner that:

(1) a single authoritative copy of the record or records exists which is unique, identifiable and, except as otherwise provided in paragraphs (4), (5) and (6), unalterable;

(2) the authoritative copy identifies the secured party as the assignee of the record or records;

(3) the authoritative copy is communicated to and maintained by the secured party or its designated custodian;

(4) copies or revisions that add or change an identified assignee of the authoritative copy can be made only with the participation of the secured party;

(5) each copy of that authoritative copy and any copy of a copy is readily identifiable as a copy that is not the authoritative copy; and

(6) any revision of the authoritative copy is readily identifiable as an authorized or unauthorized revision.

It is desirable to provide methods and systems for electronically representing records of obligations so that electronic copies of the records of obligations can be used to achieve at least some of the same ends as their paper counterparts.

### SUMMARY

In accordance with the present invention, methods and systems for electronically representing records of obligations are provided. In general, in a first aspect, the invention features a method. Content describing an obligation from an obligor to an obligee may be received and stored at a trusted server. The stored form of the content is preferably identifiable as a legally binding record of the obligation. Storing and retrieving of the record is under a protocol that uses encryption techniques to ensure that the record is unalterable, and identifiable as a current, authentic and non-repudiable statement of the rights and obligations of parties to the obligation. The content may be bound under the digital signature of an obligor of the obligation, such that the signature is affixed in a manner to attest to the assent of the obligor and to the authenticity of the content of the record. The content may additionally or alternatively be bound under the digital signature of an obligee of the obligation, such that the digital signature is affixed in a manner to ensure that any transfer of the record will be with the assent of the obligee. The content, the obligor's digital signature, and the obligee's digital signature may be bound under a digital signature of the trusted server. Consequent to a transfer of ownership of an obligation from an assignor to an assignee, a legally effective electronic record of the obligation may be generated or modified. This record may bear a digital signature of the assignor that is affixed by the trusted server in a manner sufficient to attest to the release of the obligation by the assignor. A digital signature of the assignee may be affixed to the record in a manner sufficient to ensure that any future transfer of the record will be with the assent of the assignee. When used to indicate transfer of a security interest in a property or right, the record may be stored in a form that indicates that ownership of the property or right by the obligee is encumbered by the security interest in favor of a secured party. The record may be stored under a protocol that ensures that any transfer of ownership of the record will be with the assent of the secured party. The record may be acknowledged, by the parties to the obligation and third parties, to be the single authoritative statement of the obligation. Access may be provided over a public communications network to the record. Storage and retrieval of the record may be under a protocol that ensures that all copies of information in the authoritative record are distinguishable from the authoritative record itself. The record may be stored under a protocol that ensures that a current copy of the record always bears a cryptographically verifiable record of the chain of title of the obligation.

The above advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

Further features of the invention, its nature and various advantages will be more apparent from the following detailed description of the preferred embodiments, taken in conjunction with the accompanying drawings, in which like reference characters refer to like parts throughout, and in which:

FIG. 1 is a block diagram illustrating parties accessing a trusted server in accordance with certain embodiments of the present invention;

FIGS. 2a , 3a , 4, 5a , 5b , 6, 7, 8, 9a and 9b are data structure diagrams showing electronic records, authoritative copies of the electronic records, and various components that may be part of each in accordance with certain embodiments of the present invention;

FIGS. 2b and 3b are flow charts illustrating processes for creating and assigning electronic records and authoritative copies of the electronic records in accordance with certain embodiments of the present invention; and

FIG. 3c is computer source code illustrating an example of electronic records and authoritative copies of the electronic records in accordance with certain embodiments of the present invention.

### DESCRIPTION

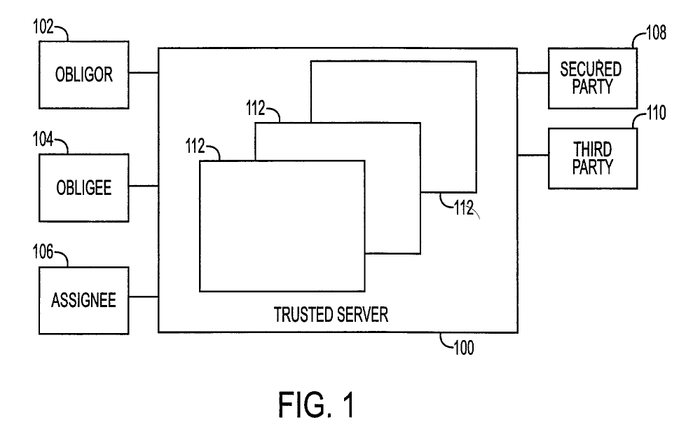

The present invention is now described in more detail in connection with FIGS. 1-10.

Referring first to FIG. 1, a block diagram is illustrated that shows a variety of parties accessing a trusted server 100. The parties may include one or more obligors 102, one or more obligees 104, one or more assignees 106, one or more secured parties 108, and one or more third parties 110. Trusted server 100 may be any suitable computer system or server for performing the functions described herein. The parties may access trusted server 100 using an access device such as any suitable computing and/or communications hardware and/or software. For example, the parties may access trusted server 100 using personal computers executing Web browser applications and communicating over the Internet. Trusted server 100 stores electronic records 112 of obligations, such as notes, chattel paper, etc. Each obligation may have one or more obligors 102 and one or more obligees 104. Server 100 may also provide features under which obligor(s) 102 and the obligee(s) 104 may originate obligations using only an electronic record 112, without ever generating a paper record.

In some implementations, the stored records may meet the definition of an “authoritative copy” under statutes such as Section 9-105 of the Uniform Commercial Code (UCC § 9-105) and the Uniform Electronic Transactions Act (UETA), and/or may meet other statutory definitions for legally binding records. In particular, the records may be stored in a form that gives them sufficient legal status so that third parties 110, e.g., traders in secondary markets, secured lenders 108, assignees 106, etc. may sufficiently establish ownership, possession, or control of the records to perfect their interests under various laws. This may improve liquidity for such obligations. In some implementations, electronic records may be bundled for securitization, etc.

Third parties 110—such as potential assignees, those who might buy an obligation on a secondary market, lenders who might take a security interest in the obligation, those doing diligence inquiries on the parties, etc.—may use trusted server 100 to search the current ownership status of the obligation. In implementations where the electronic record is the authoritative copy, the result of such a computer search may provide a degree of reliability unattainable in a search of a computerized recording index in which the paper documents are authoritative and the index is merely a non-authoritative finding aid.

In some implementations, the records may be stored using cryptographic techniques to protect the records from forgery and/or unauthorized modification, and to allow parties to the obligation and third parties to reliably and non-repudiably create records, transfer ownership of records and of obligations, inquire into the ownership of records and obligations, establish, release, and check security interests in the records and obligations, change the status of records and obligations, and/or retire records and obligations.

By reducing reliance on paper documents, market liquidity and transparency may be improved for obligations recorded in electronic form.

I. Creation of a Record of an Obligation between an Initial Obligor and an Initial Obligee

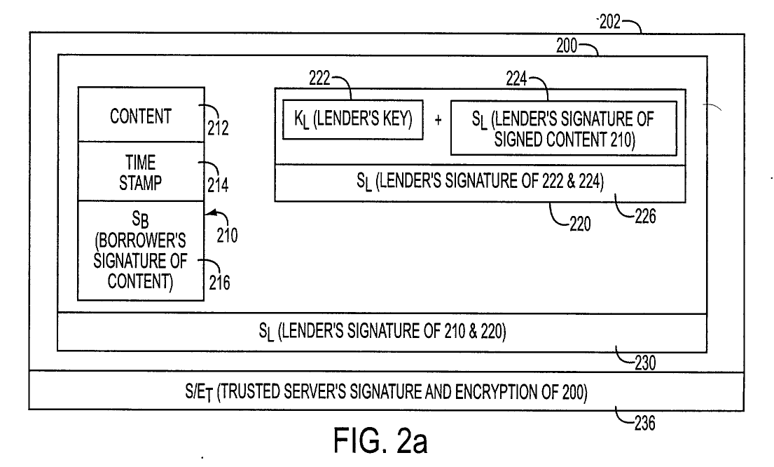

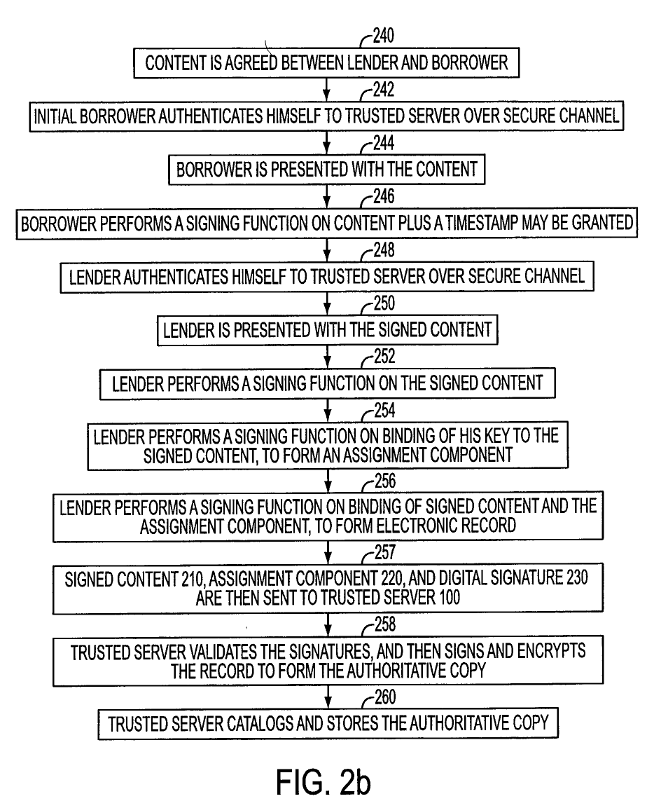

FIG. 2a shows an example of an electronic record 200 of an obligation, and an authoritative copy 202 thereof, at the completion of an initial creation process, when an initial obligor 102 and an initial obligee 104 have concluded their agreement. Electronic record 200 may be built up of three parts: signed content 210, assignment component 220, and digital signature 230 that reflects the current ownership of record 200.

Signed content 210, in turn, may include content 212, time stamp 214, and digital signature 216. Content 212 is a statement of the obligation. Content 212 may be ASCII text, a word processing document, or any other form of electronic data that states the terms of the obligation. Content 212 may bear the digital signature 216 of obligor 102 (typically the borrower on a note, the borrower on a secured loan, the lessee in a lease, etc.). Timestamp 214 records the date and time at which initial obligor 102 signed content 212. In some implementations, digital signature 216 of obligor 102 may incorporate a timestamp 214 showing the time at which content 212 was signed by obligor 102.

A “digital signature” may have one or more (and preferably all) of the following properties: (a) it may attest to the signer's intent to adopt content of a document, (b) it may be unforgeable, attesting to the identity of the person that signed the content, (c) it may be unremoveable, attesting to the identity of the content that was actually signed, (d) it may permanent and unalterable, (e) it may be keyed to the content to provide attestation that the content was not altered since being signed, and/or (f) it may be non-repudiable, making it difficult for the signer to later claim that the signature was affixed to the content without the signer's consent. In some implementations, including most of those discussed herein, a digital signature may also incorporate a timestamp indicating the time and date at which the signature was obtained. In an implementation using PKI (public key infrastructure), a digital signature may be formed by computing a hash value from content 212, and encrypting that hash value with the obligor's private key. Other digital signature techniques may also be used, some of which are discussed below.

Assignment component 220 may include: initial obligee's cryptographic key 222 (in a PKI implementation, this would be the lender's public key) and obligee's digital signature 224 of signed content 210. In some implementations, digital signature 224 is formed by computing a hash value from signed content 210, and encrypting that hash value using the initial obligee's private key. The two pieces of assignment component 220 may then be bound under digital signature 226 of initial obligee 104.

As used herein, the terms “bind” and “bound” refer to establishing data to be “bound” in a protocol in which that data may be read but not altered without the authority of a party binding that data. In preferred embodiments, data may be bound using a party's digital signature.

Signed content 210 and assignment component 220 are in turn bound together under digital signature 230 of initial obligee 104. For example, in a PKI implementation, digital signature 230 may be computed by computing a hash value from signed content 210 and assignment component 220, and encrypting the resulting hash value using the initial obligee's private key. The combination of signed content 210, assignment component 220, and the initial obligee's digital signature 230 may together constitute an electronic record 200 of the obligation.

In turn, electronic record 200 may be signed using trusted server's digital signature 236 and then encrypted using the trusted server's public key to form authoritative copy 202. For example, in a PKI implementation, trusted server's digital signature 236 is computed by computing a hash value from the combination of the signed content 210, assignment component 220 and initial obligee's digital signature 230, and encrypting that hash value with the trusted server's own private key. The authoritative copy 202 is then stored on trusted server 100.

In some implementations, trusted server 100 never exports the entirety of record 200, let alone authoritative copy 202. Trusted server 100 may only allow parties to access signed content 210 and assignment component 220, decrypting portions as demanded by parties, but preserving disclosure of some portions, and avoiding allowing a decrypted version to persist on trusted server 100 for any more than a transient amount of time. As will be discussed below, when record 200 is assigned from one owner to the next, the party currently releasing an interest in record 200 may receive only signed content 210 and assignment portion 220. A party releasing record 200 may provide a digital signature on a portion of assignment component 220 to generate a new assignment component 220 to be stored in an updated version of record 200. Because parties may not gain access to the entirety of record 200, and parties do not have access to the trusted server's private key, parties are preferably unable to forge or alter record 200 and authoritative copy 202 on trusted server 100, nor forge anything that will be recognized as an authoritative copy.

FIG. 2b shows a process for creating the structures illustrated in FIG. 2a . In step 240, an initial obligor 102 (borrower) and initial obligee 104 (lender) agree on a statement of the obligation between them. For example, when a purchaser or borrower wishes to make a purchase or borrow money on terms set by a lender, a form agreement can be automatically generated and presented by trusted server 100 to borrower 102 for the borrower's signature. The agreement may be a form lease agreement, possibly with several options that may be negotiated between lessor and lessee. In other cases, borrower 102 and lender 104 may exchange emails to negotiate an agreement, in which case the agreement may be represented as plain ASCII text. In other cases, borrower 102 and lender 104 may negotiate drafts of their agreement, using drafts prepared using a word processing program, and the system may allow for incorporation of a word processing document into content 212. In other cases, an agreement may be prepared on paper and then a graphic image of the agreement may be digitized and presented to obligor 102.

In step 242, obligor 102 connects to trusted server 100 over an authenticated and secure channel. Authentication of the identity of obligor 102 may be performed in any convenient way, for example, using a user name and password, etc. The channel may be secured using any convenient technique, for example, SSL, black box encryption, etc. In step 244, the digital form of content 212 of the obligation is provided to obligor 102. In some implementations, content 212 may be provided to trusted server 100, and trusted server 100 may in turn present content 212 to obligor's network client in a preformatted signature web page. In some implementations, trusted server 100 may present a signature page to a client with a blank box in which obligor 102 may enter content 212. In some implementations, trusted server 100 may email content 212 to obligor 102. In some implementations, content 212 may be presented to obligor 102 at a dedicated kiosk, somewhat in the manner of a dedicated ATM machine.

In step 246, obligor 102 performs a signing function on the content. This signature operation may typically be performed by the obligor's network client, for example, a client computer connected to trusted server 100 over the Internet. For example, the signing function may be performed by software that runs on the obligor's network client—many internet browsers have signature functions as built-in features. In other implementations, obligor 102 may use a stand-alone program to affix a signature 216. A timestamp 214 may also be generated. The resulting combination of content 212, timestamp 214, and obligor's signature 216 forms signed content 210. Signed content 210 may then be sent to trusted server 100, for example, using an HTTP post operation.

In step 248, obligee 104 establishes an authenticated, secure connection to trusted server 100. In step 250, signed content 210 is presented to obligee 104. For example, if the content was entered by obligor 102 without the cooperation of obligee 104, obligee 104 may review content 212. If the content was provided by a mechanism under the control of obligee 104, review may be unnecessary. In step 252, obligee 104 performs a signing function on signed content to produce a digital signature 224. In step 254, digital signature 224 of signed content 210 may be combined with the obligee's private key 222, and then bound under the lender's digital signature 226 of that combination, to form assignment component 220. In step 256, signed content 210 and assignment component 220 are bound under a digital signature 230 of obligee 104.

In some implementations, steps 252, 254, and 256 may be done automatically by the lender's computer—the computer may present lender 104 with a single copy of the content and request either “confirm” or “refuse.” If the transaction is confirmed, the computer may automatically perform the three successive signature functions, without manual intervention of obligee 104.

The combined signed content 210, assignment component 220 and digital signature 230 are then sent to trusted server 100 over the secure line established in step 248 at step 257.

In step 258, trusted server 100 validates signatures 216, 224, 226, 230, signs electronic record 200 with its own digital signature 236 and then encrypts it to produce authoritative copy 202. (Trusted server 100 can validate a public key tendered by a party by encrypting a message to the party using the public key of the party, and then by challenging the party to decrypt it. The message can only be decrypted with the party's private key. If the party sends back the plain text of the trusted server's message, then trusted server 100 can validate that the party is indeed the owner of the tendered public key.) In step 260, trusted server 100 stores authoritative copy 202.

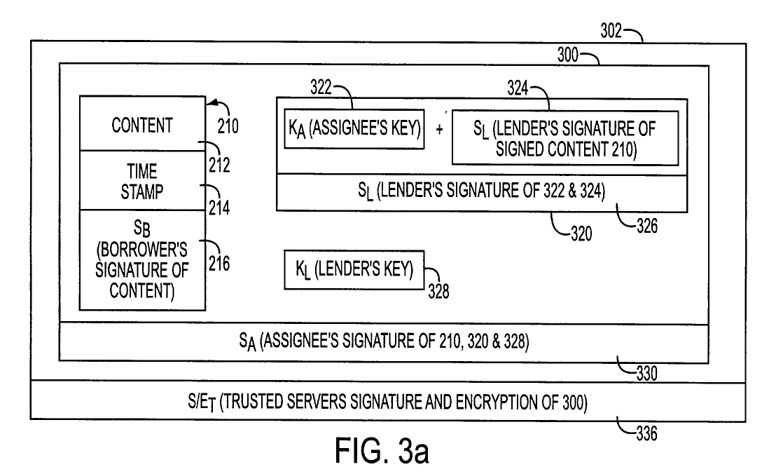

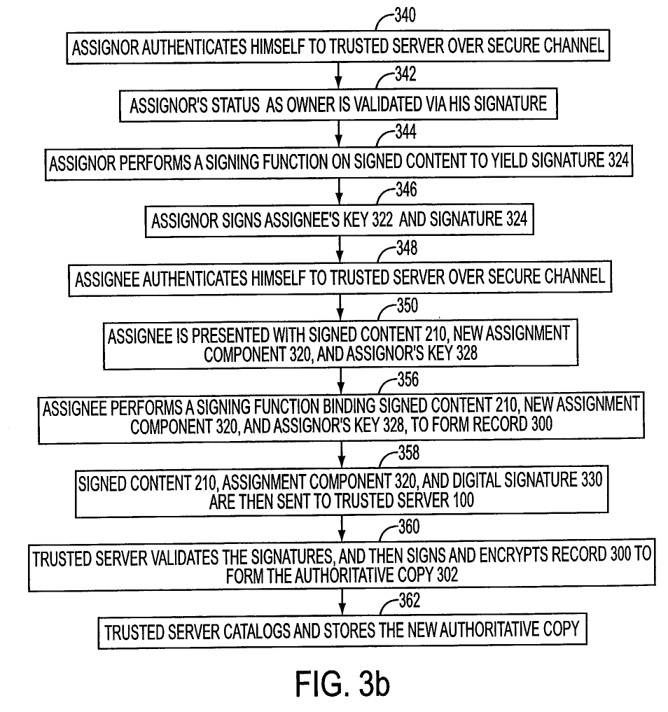

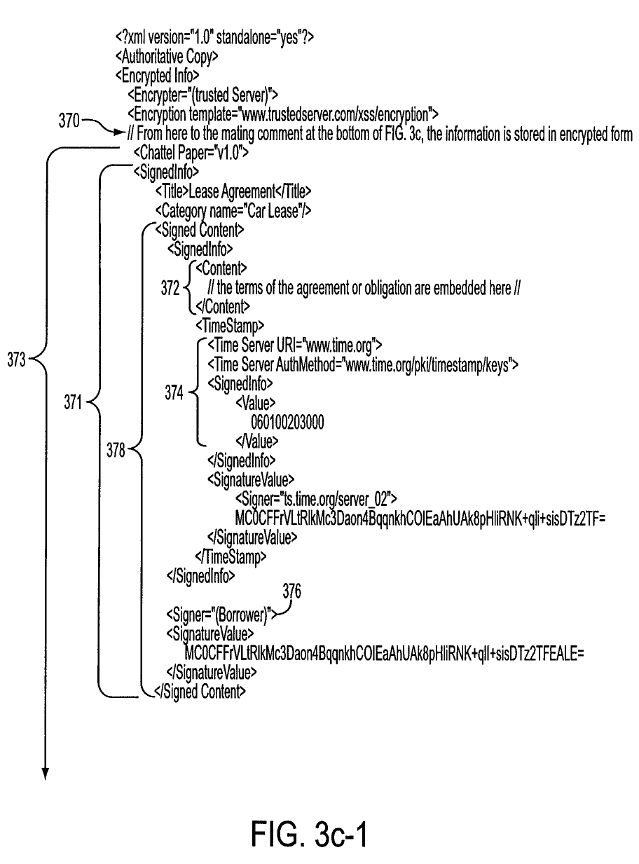

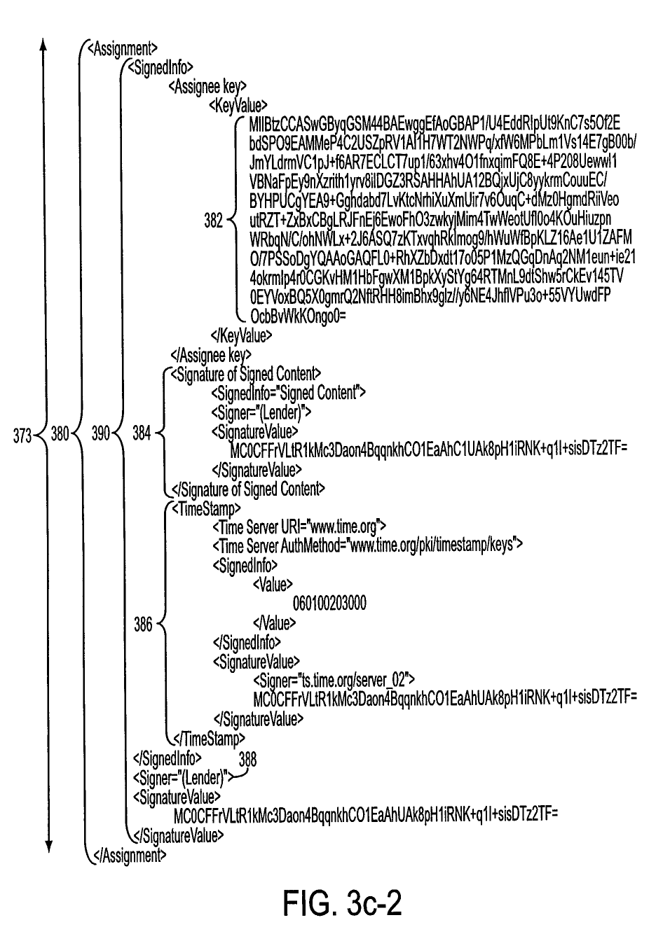

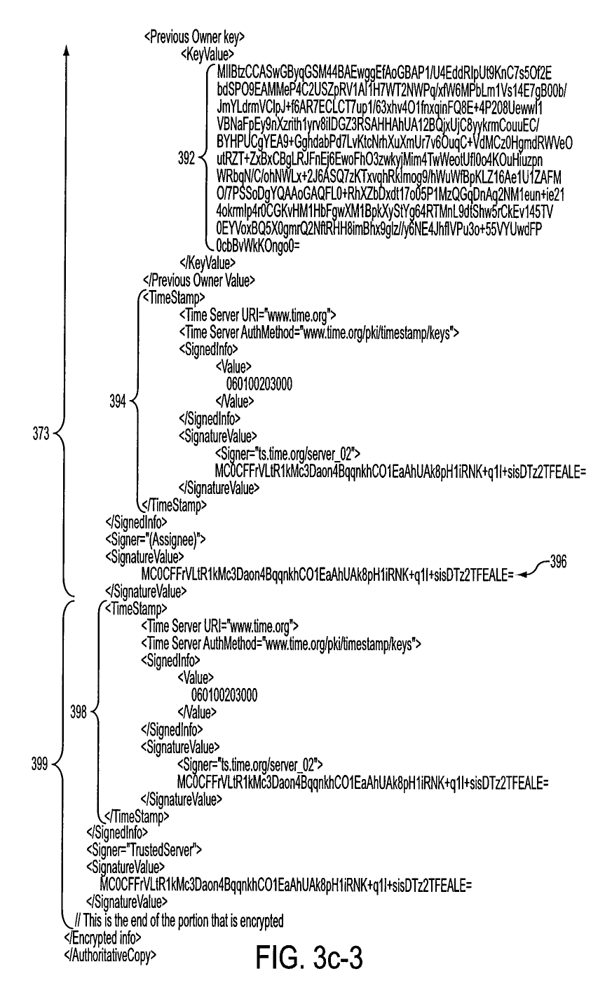

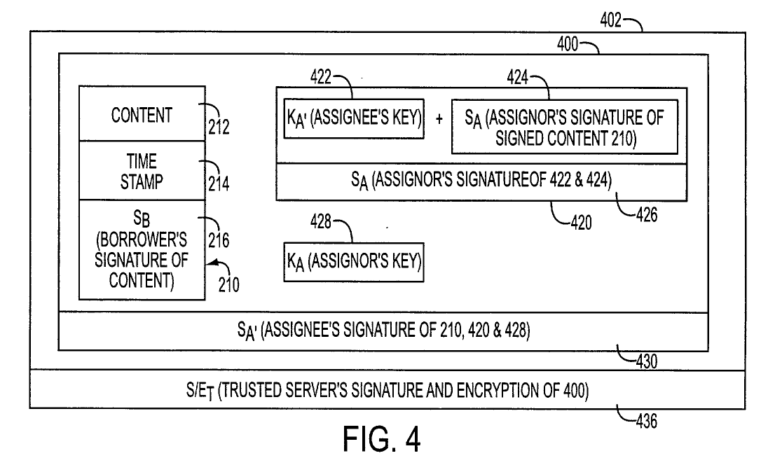

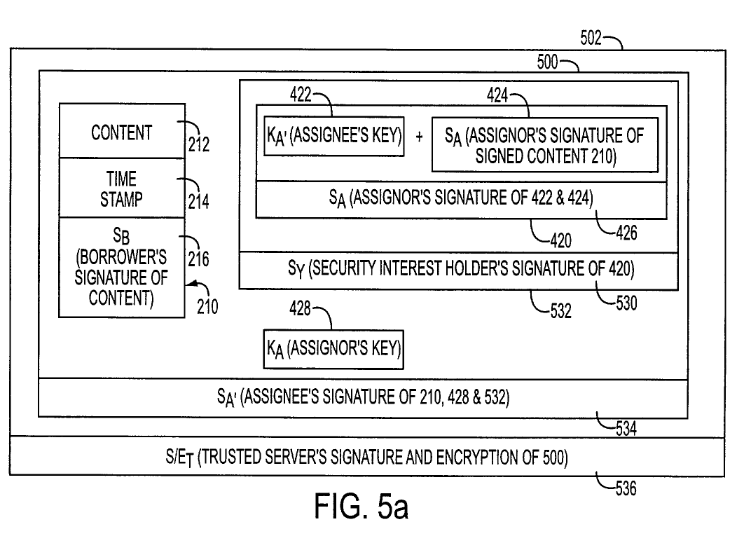

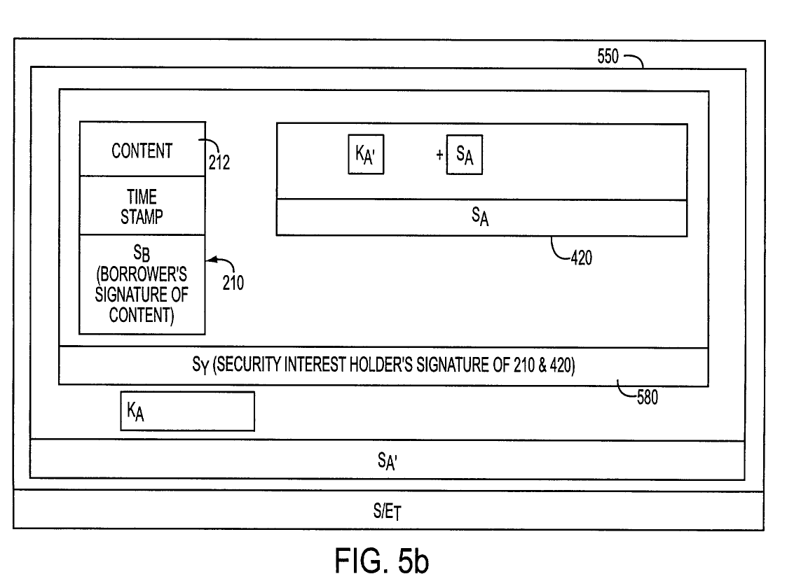

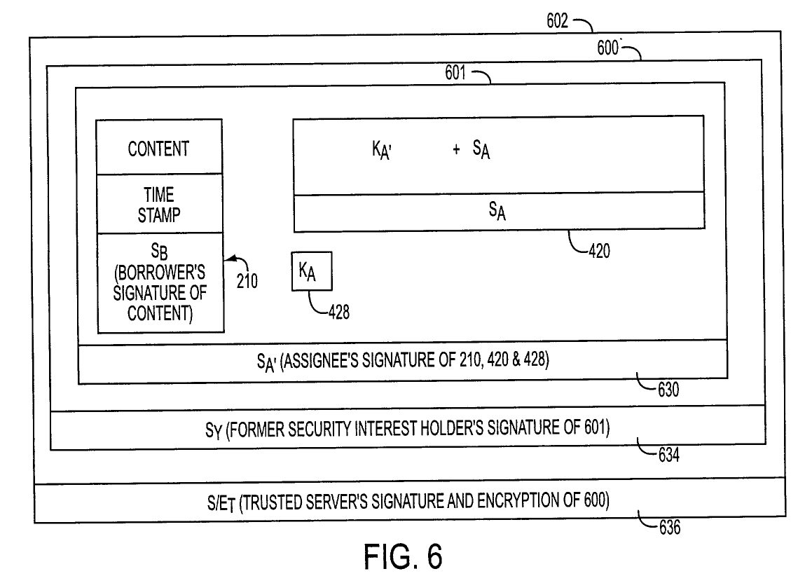

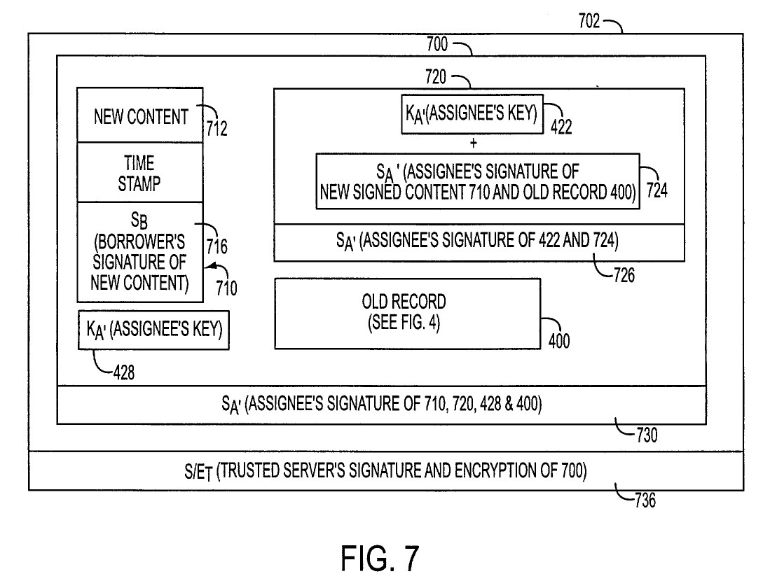

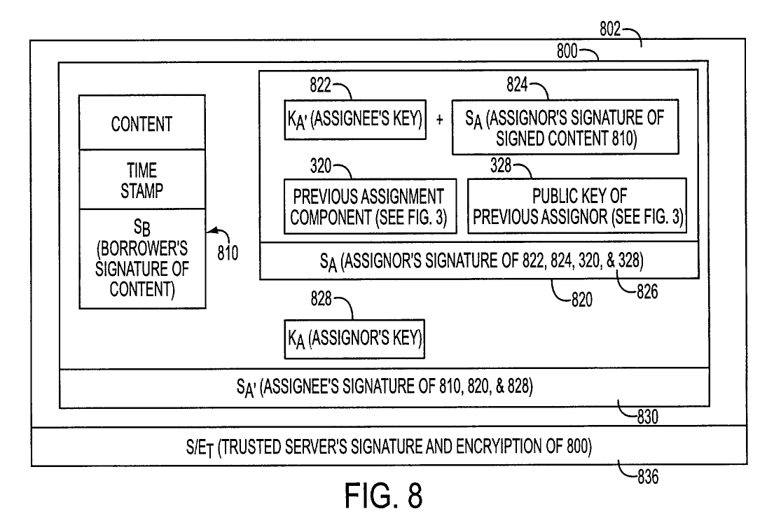

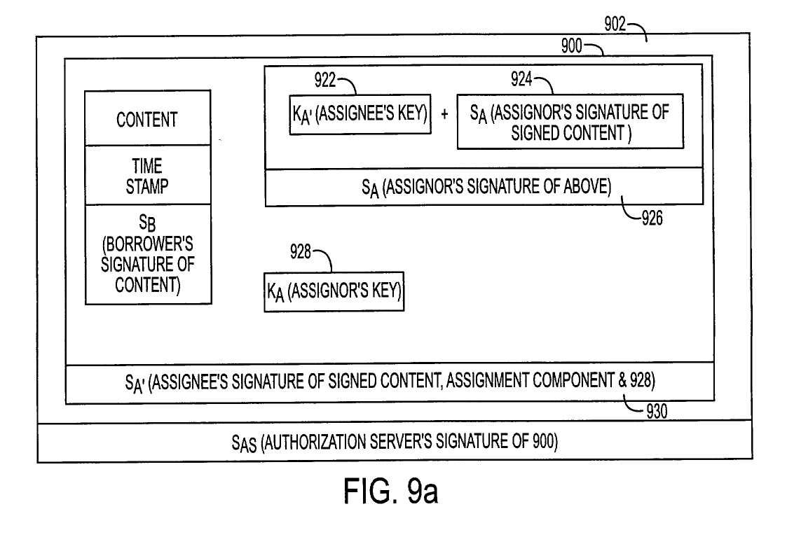

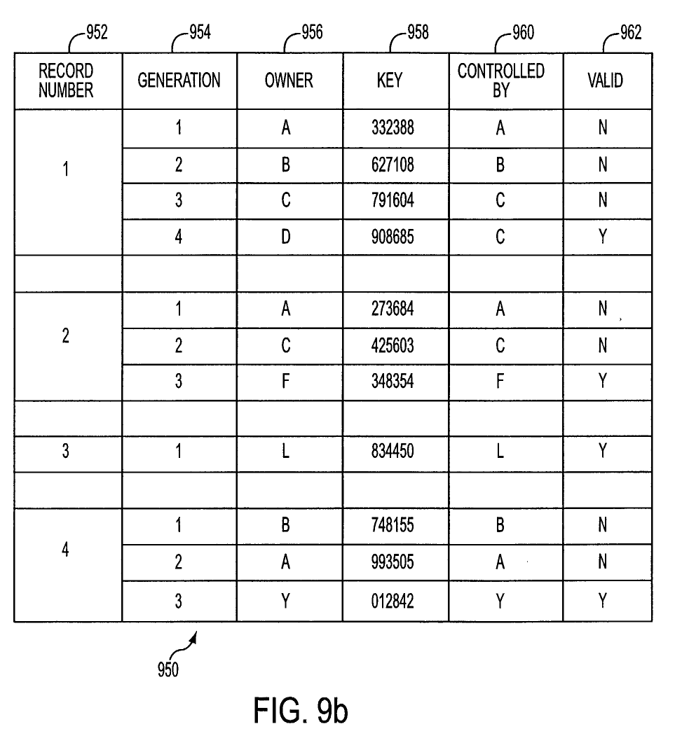

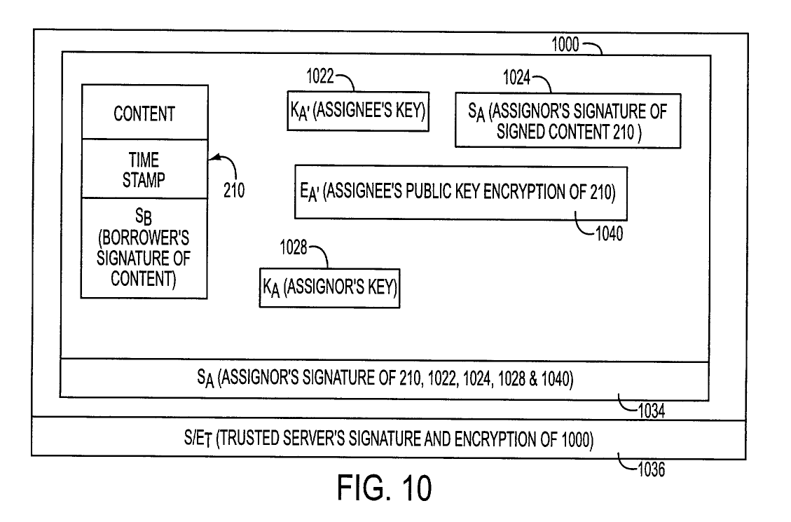

Trusted server 100 may maintain a catalog of electronic records 200 to assist in locating the records. For example, trusted server 100 may assign each record 200 a serial number or other identification label, and maintain that serial number with the record through subsequent assignments, grants and releases of security interests, and retirement of the obligation. Thus, current and prospective parties to the obligation, and third parties doing diligence inquiries on one of the parties or the obligations may be able to locate and consult the status of each record. As will emerge in the discussion of FIGS. 3-8, infra, a single record 200 may evolve over time to reflect changes in ownership interests and in the terms of the obligation. The new generations of the record may be assigned new serial numbers, or they may retain the same serial number but be assigned sequential generation numbers. A party inquiring about a record might give only the serial number, in which case trusted server 100 would return information about the latest generation of the record. A party might give a serial number and a generation number, in which case trusted server 100 would return information about that specific generation, and possibly an indication that the requested generation is not the most current generation.

Trusted server 100, in turn, may provide protected and selective access to this information. For example, any person may be able to see those obligations to which he is currently a party, but no others. Trusted server 100 may provide a facility under which a person may grant a third party the right to review all obligations to which that person is a party. That right may have a time limit—for example, a prospective borrower 102 may grant a bank the right to review all obligations to which the prospective borrower is a party during a due diligence period of two weeks.

II. Transfer of a Record of an Obligation from an Assignor to an Assignee

Referring to FIG. 3a , when the initial obligee 104 transfers electronic obligation 200 to an assignee 106, a new record 300 and an authoritative copy 302 may be generated, or the existing record 200 and authoritative copy 202 may be updated. As in FIG. 2a , after assignment, new record 300 has four parts: signed content 210, new assignment component 320, assignor's keys 328, and digital signature 330.

Signed content 210 may remain unchanged by the assignment operation in a record replacement implementation, or signed content 210 may be simply copied from old record 200 to new record 300 in a new record implementation.

Electronic record 300 may be formed by binding together signed content 210, assignment component 320, and assignor's key 328 under digital signature 330 of assignee 106. As with record 200, trusted server 100 further signs and then encrypts record 300 to produce authoritative copy 302.

Assignment may establish a record with the following properties. After the first assignment of record 200 described in content 212, assignment component 320 includes the public key 322 of the assignee 106, and the digital signature 324 of the assignor/initial obligee 104 on the signed content 210. Public key 322 and digital signature 324 of assignment component 320 are bound under digital signature 326 of the assignor/initial obligee 104. Assignee's key 322 is analogous to naming an endorsee in a conventional endorsement of a paper record, and notes the identity of the new owner 106. The assignor's digital signature 326 over the assignee's key 322 is analogous to a conventional endorsement signature in favor of the next holder, i.e., the assignor's non-repudiable attestation to the assignor's quitclaim and the new assignee's ownership. If initial assignment component (220 of FIG. 2a ) bears the signatures 224 and 226 of initial obligee 104, rather than of obligor 102, the assignment from initial obligee 104 to assignee 106 can be effected without the authorization of obligor 102.

After the first assignment, trusted server 100 may preserve the following invariants. Assignment component 320 contains public key 322 of the new assignee/obligee, and is bound under the digital signature 326 of the immediately previous owner, i.e., the last assignor. (In the initial state of a record, shown in FIG. 2, assignment component 220 is in a state that varies somewhat from this invariant: it bears a digital signature 226 of initial obligee, rather than the digital signature of the immediately past obligee—because none exists.) Key component 328 will hold a copy of the public key of the immediately previous assignor. Trusted server 100 preferably will not release key 328 to parties. By storing assignor's key 328, secure server has available the key necessary to validate signatures 324 and 326, so that record 300 can be assigned in the future, without further authorization of the past assignor.

(To consider an example, in a public key implementation, a digital signature may be validated as follows. The hash value of the components bound under the signature is computed. Then, the signature value is decrypted with the stored public key 328. If the decrypted signature matches the hash value, then the signature must have been generated with the signer's private key.)

FIG. 3b shows a process for creating an assignment structure as illustrated in FIG. 3a . In connection with this figure, 200-series reference numbers will be used to refer to the incoming record being assigned, and 300-series reference numbers will be used to refer to the new record being built by the assignment process. In step 340, an assignor 104 connects to trusted server 100 over an authenticated and secure channel. In step 342, server 100 validates that the purported assignor 104 is the current owner, using key 222 and digital signature 230 (FIG. 2). In a decentralized system, the assignor's status as owner may be validated by checking assignor's status on an authorization server. In step 344, assignor 104 performs a signing function on signed content 210 to produce digital signature 324. In step 346, assignor 104 signs the contents of the assignment component, that is, assignee's key 322 plus assignor's signature 324, to produce new assignment component 320.

In step 348, assignee 106 establishes an authenticated and secure connection to trusted server 100. In step 350, signed content 210, new assignment component 320, and assignor's key 328 are presented to assignee 106. In step 356, signed content 210, new assignment component 320, a timestamp (not shown in FIG. 3a ), and assignor's key 328 are combined and assignee 106 performs a signing function on the combination to compute a digital signature 330 of this combination and to form record 300. Signature 330 attests to the assignee's ownership of record 300. The combined signed content 210, assignment component 320 and digital signature 330 are then sent to trusted server 100 over an established secure line at step 358.

In step 360, trusted server 100 validates signatures 216, 324, 326, 330, encrypts electronic record 300 and then signs the record with its own digital signature 336 to form authoritative copy 302. In step 362, trusted server 100 stores authoritative copy 302.

In some alternatives, the trusted server may sign record 300, and then encrypt the signed record to produce authoritative copy 302.

In some implementations, between step 344 and step 356, record 200 may be in an “assignment-pending” status. Third parties doing diligence on the obligation may be able to determine that an assignment is pending. If an assignor 104 attempts to initiate a second assignment of the obligation or of record 200, trusted server 100 may respond by canceling the partially completed previous assignment and notifying the jilted assignee, by blocking the attempted re-assignment, or by notifying the assignor 104 of the conflict and allowing the assignor to select from among the previous alternatives.

In some implementations, trusted server 100 may be programmed to recognize that a record has been in “assignment-pending” status for an unreasonably long time. Trusted server 100 may take an escalating series of actions, for example, by first sending an email to the party whose action is pending, and culminating with unwinding the entire pending assignment, returning the record to the state shown in FIG. 2a .

Referring to FIG. 3c , records 200 and 300 and authoritative copies 202 and 302 may be implemented in a number of different technologies, including HTML or XML documents, MIME or SMIME, relational database tables, proprietary record formats managed by custom-written programs written in higher-level languages, etc. FIG. 3c shows an example implementation in XML of authoritative copy 302, after a first assignment to a first assignee. For clarity, the example of FIG. 3c omits much of the “housekeeping” code, pointers to methods, key length, support infrastructure, URL's for templates and DTD's, etc.

At line 370, a comment notes that most of the body of authoritative copy 300 as designated by section 373 would be stored in encrypted form.

As stated above, signed content 210, as represented by section 371, may include content 212, timestamp 214, and signature 216. Content 212 may be included at line 372, as indicated by the comment line. Time stamp 214 may designate a time server as shown at line 374. Line 376 indicates the identity of the borrower 102. This identity indication may be in a form that allows easy lookup in a public database of the borrower's public key. Content 212 and timestamp 214 are bound under the borrower's digital signature 216 as shown at section 378. The XML definition of a digital signature may encapsulate content 212, timestamp 214 and signature value 216.

Assignment component 320 is shown in section 380 of page 2 of FIG. 3c . Assignment component 320 may include assignee's key 322 (as represented by section 382), the last assignor's digital signature 324 (as represented by section 384) of signed content 210, an indication of the identity of the last assignor (as represented by line 388), and the assignor's signature 326 of assignment component 320 (as represented by section 390). Signature 324 may also encapsulate a timestamp as shown at section 386.

Page 3 of FIG. 3c completes the XML representation of FIG. 3a . As illustrated, the public key 328 of the last assignor may also be stored as shown by section 392. A timestamp for assignment component 330 may record the time at which the assignee signed (as represented by Section 394). Digital signature 330 attests to the assignee's ownership of the obligation identified by record 300 as represented by line 396.

Trusted server 100 may apply its timestamp and digital signature 322 to the record as represented by section 398 and section 399, respectively. As noted by the comment at the end of FIG. 3c , almost the entire body of the record may be stored in encrypted form.

FIG. 4 shows the state of the record after it has been assigned a second time, from an assignor A to an assignee A′. Signed content 210 remains unchanged. Assignment component 420 includes key 422 of A′ (the assignee in the most recent assignment) and digital signature 424 of A (the assignor in the most recent assignment) of signed content 210, and is signed with digital signature 426 by A (the assignor in the most recent assignment). Record 400 may also include key 428 of the most recent assignor, in this case, A. Record 400 may be bound under signature 430 of the most-recent assignee A′. The authoritative copy 402 of record 400 may be formed when trusted server 100 signs record 400 and then binds the record under its own signature 436.

III. Security Interests

Referring to FIGS. 5a and 5b , a secured party may take a security interest in an obligation and may take control of an electronic record, while the obligation itself remains in the ownership of the last assignee. FIG. 5a shows the case where the consent of the secured party is required for any further assignment of the obligation, but not for amendment of the signed content 210 memorializing the obligation. FIG. 5b shows the case where the consent of the secured party is required for both assignment and amendment. Both FIGS. 5a and 5b assume that the obligation is currently owned by the second assignee A′, as shown in FIG. 4. In both FIGS. 5a and 5b , signed content 210 and assignment component 420 remain unchanged. In both FIGS. 5a and 5b , public key 428 of the last assignor is stored.

In FIG. 5a, assignment component 420 may be bound under digital signature 530 of the secured party. Thus, assignment component 420 cannot be altered (and thus record 500 cannot be further assigned) without the consent and participation of the secured party; however, the terms of the obligation as memorialized in content 212 may be renegotiated between the obligor and the current assignee without the participation of the secured party.

In one example, authoritative copy 502 may be created by the following process. When a grantor (A′ in FIG. 5a) wants to grant a security interest to a grantee (Y in FIG. 5a), the grantor may log into trusted server 100. Trusted server 100 may validate the identity of the grantor, and that the grantor is the current owner. The grantor may ask trusted server 100 to create a security interest in favor of the grantee. Trusted server 100 may then send assignment component 420 to the grantee. For example, trusted server 100 may email a document to grantee for the grantee's signature, or the grantee may gain access to assignment component 420 by logging into the trusted server's web site and clicking on buttons presented on the site. The grantee may bind assignment component 420 with his signature 530. Trusted server 100 then sends signed content 210, signed assignment component 532, and the prior assignee's key 428 to the grantor (again, any convenient method may be used, including email or a web site). The grantor may bind these components under his digital signature 534 to produce record 500.

In this implementation, this final signature 534 is the legally binding signature, equivalent to a conventional signature by a grantor that creates the security interest. Trusted server 100 then signs and encrypts record 500 to form authoritative copy 502. In some implementations, trusted server 100 may coordinate with the grantee's bank, so that an electronic funds transfer occurs when signature 534 is received.

In some implementations, either party may cancel the transaction by notifying trusted server 100 before the grantor signs 534, or the transaction may be automatically cancelled if grantor simply fails to attach digital signature 534. After cancellation, record 402 remains the authoritative copy.

In some implementations, trusted server 100 may record that the record is in a “grant-pending” status between the time the grantor initially requests the grant and the time that the grantor finally gives signature 534. This “grant-pending” status may be handled analogously to the “assignment-pending” status discussed above in connection with FIG. 3c .

In FIG. 5b , both signed content 210 and assignment component 420 may be bound under digital signature 580 of the secured party. In such an implementation, neither signed content 210 nor assignment component 420 may be altered without the participation of the secured party. This may be achieved by a similar sequence of messages between grantor, grantee, and trusted server 100.

Generally, a security interest is coupled with some other obligation. In some implementations, the system may be programmed to coordinate the creation of the new obligation with the creation of the security interest. For example, in parallel with the process of creating the security interest in an old obligation described in connection with FIGS. 5a and 5b , trusted server 100 may in parallel perform the steps of FIG. 2b , to create a new obligation. The content 212 of the new obligation may include an explicit reference to the old obligation, for example, referring to the old obligation by a serial number or other identification assigned by trusted server 100. In turn, these references may be bound under some form of validation by trusted server 100.

Referring to FIG. 6, when party Y releases his security interest, record 600 may be created. The current owner, that is, the party to whom the security interest is released (A′ in FIG. 6), signs signed content 210, assignment component 420, and last assignor's key 428 with signature 630 to create component 601. Then, the party releasing the security interest (Y in FIG. 6) binds signed content 210, assignment component 420, last assignor's key 428, and signature 630, i.e., component 601, with digital signature 634. Digital signature 634 is a non-repudiable attestation of releasor Y that the security interest is released. Trusted server 100 signs the items bound by and including releasor's signature 634 with digital signature 636, and then encrypts and stores the same resultant as authoritative copy 602. Because the secured party's signature is only bound under the signature of trusted server 100, no further participation by the secured party will be required if and when record 600 is to be assigned again.

In some implementations, after release of a security interest, the state of the record may return to the state shown in FIG. 4, in which no artifact of the secured party's ownership remains in the record. In such an implementation, trusted server 100 may maintain a catalog of which records 200, 300, 400, 500 are current and which are not. With no such artifact in any copy that is recognized as current by trusted server 100, the former secured party may be without basis to assert that a security interest was ever in place. As long as any copies of records 500 and 550 are no longer recognized as current, no release signature by the secured party is required to be stored in the post-release record.

IV. Amendments

Referring to FIG. 7, the parties may agree to amend terms of the obligation—for example, the parties may agree to reschedule payments, or may agree to substitute collateral. Under conventional rules of secured lending, the amended agreement (and any security interests therein) will relate back to those in effect before amendment. FIG. 7 assumes that the obligation, under the original terms, was owed by original borrower B (as shown in FIGS. 2a , 3a and 4) to an assignee A′ (as shown in FIG. 4).

The new terms 712 of the obligation may be expressed as ASCII text, a word processing document, etc., as with original content 212. New content 712 may be bound under digital signature 716 of borrower B 102 to form a new signed content 710. New signed content 710 and old record 400 (FIG. 4) may be presented to current obligee A′ for signature 724. (Note that signature 724 is only stored as a signature, that is, at the size of a hash value. In this implementation, neither signed content 710 nor old record 400 are actually stored directly as part of signature 724.) Then, key 422 of the current owner and signature 724 may be bound under digital signature 726 of current obligee A′ to form a new assignment component 720.

Assignment component 720, current assignee's key 428, and the entire old record 400 may then be bound together under the current assignee's digital signature 730 to form new record 700. (In some implementations, old record 400 may be stored as a document serial number and generation number of the previous record, rather than being bodily stored within record 700.) Record 700 may be signed with digital signature 736 and encrypted by trusted server 100 to form authoritative copy 702.

Note that record 700 differs from record 400 in two respects. First, signature 724 is computed over both current signed content 710 Oust as signature 424 is computed over current signed content 210), and old record 400. Second, signature 730 encapsulates a new component, the entire old record 400. This latter component has no analogous component in record 400.

Note that record 700, for the case of amended content, is in some respects a record of a new obligation—the signed content component 210 that persisted through other changes of ownership and that has now been modified. Trusted server 100 may maintain the relationship between new record 700 and old record 400, for instance by maintaining an image of old record 400 within record 700, so that the legal priority position of record 700 can be seen to relate back to the priority position of initial record 400. In future assignments going forward from FIG. 7, old record 400 may be carried forward, and future signatures 724 will continue to be computed over both new signed content 710 and old record 400. Thus, any party may have a reliable mechanism to inquire as to current and previous terms of an obligation.

In the event of a security interest over an amended obligation, then the secured party may sign new signed content 710, new assignment component 720, and old record 400, and may either sign inside or outside the current owner's signature 730, as discussed in connection with FIGS. 5a and 5b , depending on whether the secured party demands its consent for further transfers.

V. Endorsement Lineage

Referring to FIG. 8, trusted server 100 may maintain a cryptographically secure, provable endorsement lineage of record 800. FIG. 8 corresponds to FIG. 4, in that the most recent transfer of record 800 was an assignment from assignor A to assignee A′. In the implementation illustrated in FIG. 8, assignment component 820 may encapsulate signature 824 of last assignor (A) of current signed content 810, and the current owner's key 822, just as in FIG. 4. In addition, assignment component 820 may encapsulate the previous assignment component 320 and public key 328 of the assignor in that previous transaction.

In the next assignment, the entire assignment component 820 and current owner's key 828 may be encapsulated under the signature of the current owner to form the next assignment component. This next assignment component may result in a three-level embedding of the original assignment component 320. Each succeeding assignment and nesting may add the size of one key and one signature; thus, the overhead for maintaining this lineage may be relatively small. At a later date, parties may inquire into the entire past history of record 800, and that history may be self-authenticating and non-repudiable, subject to the security of the key infrastructure.

VI. Decentralized Storage of Records

The discussion above has assumed that the only copy of the authoritative copy of a record is the one stored on trusted server 100, and that trusted server may enhance the security of the records by allowing access to only so much of a record as a party needs. Referring to FIG. 9a , in another implementation, an authentication server may be used that does not actually store the records. Instead, storage of records may be decentralized—copies may be stored by the parties themselves. There may be arbitrarily many copies shared arbitrarily widely, each indistinguishable from the next.

When a party needs to inquire into the validity of a record, for example to establish ownership of a prospective assignor before the party gives value for an assignment of the obligation, the party may present a copy of the record to an authentication server. The authentication server may validate whether the copy is a correct and current copy of the state of the record.

When the parties agree on an assignment, they may create a new record, and give the record to the authentication server. The authentication server may bind record 900 under its signature 936, and store indexing information about the record. Then the authentication server may send the signed authoritative copy 902 back to the parties

FIG. 9a shows a record 900 in the same state as record 400 of FIG. 4—that is, the record has been assigned from assignor A to assignee A′. Keys 922 and 928 may be stored in the same way as keys 422 and 428; signatures 924, 926 and 930 are analogous to signatures 424, 426, and 430. However, record 900 may be bound under the signature 936 of the authentication server, without being encrypted.

In some implementations, key 928 may be a one-time key that is issued to a party when the record is assigned to the party, and then retired by the authentication server when record 900 is further assigned. For example, as shown in FIG. 9b , the authentication server may store an index 950. Index 950 may be indexed by record identification serial number in column 952 and generation indicator in column 954 (or owner identification in column 956) to a key in column 958. Index 950 may have an additional column 962 to record whether the key is valid or invalid, or the authentication server may simply note whether the key in column 958 corresponds to the latest generation of a record (in which case the key is valid) or an earlier generation (in which case the key is invalid). Other indexing technologies may be used for index 950, for example, one or more relational database tables, a hierarchical database, OCSP, LDAP (lightweight directory access protocol), an SQL database, etc. As each assignment occurs, the authentication server may destroy the key for the retired generation. In another alternative, the authentication server may simply mark the old key as being obsolete, so that any future inquiry may be able to validate that the record was once correct, but is no longer, and may not be used to validate any further transaction on the record.

In a decentralized implementation, the protocol between parties and the authentication server may be implemented in a number of ways. Parties may email documents to the authentication server, and the authentication server may acknowledge that the document is current, obsolete, or totally invalid. Software running on a user's computer may compute a hash of the document, and request that the authentication server confirm the hash value.

In some implementations, for instance that shown in FIGS. 2a , 3a , 4, 5a , 5b , and 6-9b , the protections offered by the digital signatures and the trusted nature of trusted server 100 may be somewhat redundant. That is, by protecting against external exposure of an entire record and validating the identity of parties, trusted server 100 provides much of the required security control even without the digital signature protocol described above. Similarly, the digital signature protocol may provide the required security control even without hosting storage on a trusted server. Thus, records may move into and out of a trusted server environment—when it is more convenient to store the records on a trusted server, the parties may agree to do so. When it becomes more convenient to transfer the records to a decentralized storage system that relies only on the digital signatures, the parties may do so.

VII. Assignment without the Participation of the Assignee

Referring to FIG. 10, in another implementation, a record may be stored in a form that allows assignment of the obligation without the active participation of the assignee. Signed content 210 is unchanged from the implementations of FIGS. 2-9. Rather than an integrated, signed assignment component, record 1000 stores three constituent pieces. Component 1022 is the public key of the current assignee. Component 1024 is the digital signature of the most-recent assignor for signed content 210. Component 1040 is signed content 210 encrypted with the public key of the most recent assignee. Signed content 210, assignee's key 1022, assignor's signature 1024, assignor's key 1028, and the encrypted signed content 1040 are all bound together under the digital signature 1034 of the most-recent assignor.

The inclusion of the encrypted signed content puts the record under a “lock” that can only be opened with the current owner's private key. This protects against further assignment of record 1000 without the authorization of the current owner. Note that component 1040 can be created without the direct participation of the assignee, because it relies on only the assignee's public key.

The entire contents of record 1000 may be signed with digital signature 1036 and then encrypted by trusted server 100.

VIII. Electronic Forms of Conventional Tangible Records

Tangible records, for example conventional chattel paper or notes, may be converted to electronic form. Official Comment 3 to UCC § 9-105 notes that “When tangible chattel paper is converted to electronic chattel paper, in order to establish that a copy of the electronic chattel paper is the authoritative copy, it may be necessary to show that the tangible chattel paper no longer exists or has been permanently marked to indicate that it is not the authoritative copy.”

In one implementation, parties may decide to deposit their copies of tangible chattel paper (or other obligations) with a custodian, for instance the party that operates trusted server 100 or the validation server. This custodian may construct a record that reflects the current terms of the obligation, the effective dates of the obligation, and the current state of ownership, and then permanently mark each tangible obligation to indicate that it is no longer the authoritative copy. The newly constructed records may then be stored on trusted server 100, or distributed to the parties for use in a decentralized form, as discussed in section VI.

In another implementation, an account or trust may be created that serves a role analogous to a securities entitlement account, or DTC (the Depository Trust Company, a non-profit corporation that serves as the recognized custodian in the securities industry). The account or trust may hold the tangible copies of the records, and then create electronic records naming the same parties as the tangible records, as discussed above. In such an arrangement, the electronic records may trade as the proxies for the tangible paper held by the organization or trust. A statutory amendment may specify that such an electronic record is a perfect substitute for the tangible record, for instance, that the priority of any interest in the electronic record relates back to the priority date of the corresponding interest in the underlying tangible record.

Similarly, trusted server 100 may provide a way of generating tangible copies of electronic records for those occasions where a paper document is needed. For instance, trusted server 100 may qualify as a “custodian” of the records under hearsay and best evidence rules. Records 100 may be self-authenticating as “commercial paper, signatures thereon . . . to the extent provided by general commercial law.”

IX. Additional Features and Alternative Implementations

Trusted server 100 may be a trusted server that uses encryption, is subject to physical access controls, and has been subjected to the auditing procedures known in the art for establishing a secure server.

The discussion above has used public key infrastructure encryption as the underlying security mechanism. Other implementations are possible using other encryption mechanisms, including Diffie-Hellman encryption, Kerberos, Secure I.D. tokens, one-time passwords, etc.

For ease of explanation, the example implementations of FIGS. 1-10 use the same technology for all digital signatures. However, different digital signature technologies may be used at different times, to achieve different purposes. For example, in a transfer of a negotiable instrument, the assignee need not assent or attest to anything The digital signature of the assignor merely attests to a quitclaim—the identity of the assignor is no longer material to the state of the record, and that assignor no longer has any interest in protecting against alteration. The assignee's interest in the record is merely to have the record identify the new owner, and to protect against unauthorized alteration of the record. Thus, an implementation may use two different digital signature technologies to achieve these different purposes.

Referring again to FIGS. 2a and 3a , in another implementation, initial record 200 may be created storing the initial obligor's key in the storage slot that will in the future be used for the past assignee's key, and signatures 224 and 226 may be those of the initial obligor 102. This allows the invariants discussed above in connection with FIG. 3a to be carried back to record 200, so that the information content of initial record 200 is more closely analogous to the information content of records that have been assigned.

In another implementation, keys 222, 322 and 328 may not be actually stored in records 200 and 300. Instead, records 200 and 300 may store an alternative indicator of the current owner's identity, and that indicator may be used to consult a database of public keys to obtain the keys used for assignment.

Referring again to FIG. 9b , an implementation may combine the digital signature techniques of FIGS. 2a , 3a , and 4-9a with the recording table technique of FIG. 9b . Some information may be stored redundantly. In some implementations, less information may be bound under signature, and simply stored in a database table.

Index table 950 may include a “controlled by” column that corresponds to “control” in revised Article 9 of the UCC, and “possession” in older law. Thus, a record could potentially be owned by one party, encumbered by a security interest to a second, and “controlled” by a third. In more likely scenarios, the record would be “controlled” by a party holding a security interest, or by the owner if there is no outstanding security interest.

In some implementations, the key length may vary based upon the characteristics of the party or the obligation. For instance, in an implementation directed to consumer loans, obligor's obligations may be in the range of thousands of dollars, obligees' obligations may total in the millions of dollars, and trusted server 100 as a whole may store records in the billions of dollars. In such an implementation, trusted server 100 may use a 2048-bit key, obligees may use 1024-bit keys, and obligors may use 512-bit keys. In another implementation, trusted server 100 may use many different keys, so that the value to intruders, and the risk to the overall system, of cracking any given key is reduced.

A number of encryption and digital signature techniques are set out in Bruce Schneir, Applied Cryptography, 2d Ed. (1996), especially Chapters 2, 4, 20 and 23, Alfred J. Menezes et al., Handbook of Applied Cryptography (1997), especially Chapters 11 and 15, Vesna Hassler, Security Fundamentals for E-Commerce (2001), and Mostafa Sherif, Protocols for Secure Electronic Commerce (2000). These volumes are hereby incorporated by reference herein in their entirety. The encryption and digital signature methods discussed in these volumes, and others as well, may be substituted for the public/private key methods given in the above examples.

In some implementations, encryption operations may be performed using a system that allows some access by trusted server 100 or the authentication server. For instance, such a systems might use an encryption technique analogous to the National Security Agency's Clipper, that allows “eavesdropping” by an appropriately permitted party. These features may be useful for cases where a current owner of a record has become unavailable, or where an involuntary transfer must be effected (e.g., in foreclosure, bankruptcy, or forfeiture in a criminal case). Alternatively, trusted server 100, the authentication server, or a key escrow may hold a copy of each party's private key for use in such eventualities.

An organization may be formed to be the custodian of the account or trust, and/or trusted server 100 or the authentication server. This organization may be formed as a corporation, limited liability partnership or other business organization, under the aegis of a consortium of companies in a related market. For instance, the large automobile manufacturers may form such an organization to form and operate the legal and technological infrastructure to create, manage and retire the chattel paper generated to finance the sale of new automobiles. Similarly, a consortium of banks or finance companies may collaborate to form the legal and technological infrastructure to create, manage, and retire consumer or commercial loans, either secured or unsecured.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Further undescribed alternative embodiments are possible. It will be appreciated that many of those undescribed embodiments are within the literal scope of the following claims, and others are equivalent.

We claim:

1. A method of storing and binding content describing an obligation from an obligor to an obligee, comprising the steps of:
storing the content on a trusted server;
binding the content under a digital signature of the obligor;
binding the content under a digital signature of the obligee to form a record of the obligation;
binding the content, the digital signature of the obligor, and the digital signature of the obligee under a digital signature of the trusted server to form an authoritative copy of the record;
receiving a digital signature of an assignor of the obligation that attests to release of the obligation by the assignor;
storing the digital signature of the -assignor as part of the record;
receiving a digital signature of an assignee of the obligation;
affixing the digital signature of the assignee to the record;
requiring receipt of identity corresponding to the digital signature of the assignee to ensure that the assignee agrees to a transfer of the obligation;
indicating in the record that ownership of the obligation is encumbered by a security interest in favor of a secured party;
requiring consent of the secured party before a transfer of the obligation; and
providing access over a communications network to the record.

2. A method of storing content relating to an obligation owed by an obligor, comprising the steps of:
binding the content describing the obligation under a digital signature of the obligor to form signed content;
binding an encryption key of an assignee of the obligation and a digital signature of an assignor of the signed content with a digital signature of the assignor to form an assignment component; and
binding the assignment component and the signed content with a digital signature of the assignee to form an electronic record.

3. The method of claim 2, further comprising the step of affixing a digital signature of a trusted server to the electronic record to form an authoritative copy.

4. The method of claim 3, wherein the authoritative copy is stored on a trusted server.

5. The method of claim 3, wherein the authoritative copy is encrypted.

6. The method of claim 2, further comprising the step of binding an encryption key of the assignor with the digital signature of the assignee.

7. The method of claim 2, further comprising the step of requiring a receipt of identity corresponding to the digital signature of the assignee to ensure that the assignee agrees to a transfer of the obligation.

8. The method of claim 2, further comprising the step of receiving the content as a scanned image of a physical document.

9. The method of claim 2, further comprising the step of receiving the content as an email message.

10. The method of claim 2, further comprising the step of receiving the content as a word processing document.

11. The method of claim 2, further comprising the step of receiving the content as a text document.

12. The method of claim 2, further comprising the step of receiving input from a party to compose the content.

13. The method of claim 2, wherein the digital signature of the obligor is an attestation of the obligor to the accuracy of the content.

14. The method of claim 2, wherein the digital signature of the obligor attests to the identity of the content.

15. The method of claim 2, wherein the digital signature of the obligor comprises a hash value encrypted using a key.

16. The method of claim 2, wherein the digital signature of the obligor uses public key infrastructure technology.

17. The method of claim 2, wherein the digital signature of the obligor comprises a time stamp.

18. The method of claim 2, wherein the signed content is stored on a trusted server.

19. The method of claim 2, wherein the electronic record is stored on a trusted server.

20. The method of claim 2, wherein the signed content is encrypted.

21. The method of claim 2, wherein the electronic record is encrypted.

22. A method of storing content relating to an obligation owed by an obligor to an obligee, comprising the steps of:
binding the content describing the obligation under a digital signature of the obligor to form signed content;
binding, under a digital signature of the obligee, a digital signature of the obligee of the signed content and an encryption key of the obligee, to form an assignment component;
binding the signed content and the assignment component under the digital signature of the obligee to form an electronic record.

23. The method of claim 22, further comprising the step of affixing a digital signature of a trusted server to the electronic record to form an authoritative copy.

24. The method of claim 23, wherein the authoritative copy is stored on a trusted server.

25. The method of claim 23, wherein the authoritative copy is encrypted.

26. The method of claim 22, further comprising the step of:
requiring receipt of identity corresponding to the digital signature of the obligee to ensure that the obligee agrees to a transfer of the obligation;

27. The method of claim 22, further comprising the step of receiving the content as a scanned image of a physical document.

28. The method of claim 22, further comprising the step of receiving the content as an email message.

29. The method of claim 22, further comprising the step of receiving the content as a word processing document.

30. The method of claim 22, further comprising the step of receiving the content as a text document.

31. The method of claim 22, further comprising the step of receiving input from a party to compose the content.

32. The method of claim 22, wherein the digital signature of the obligor is an attestation of the obligor to the accuracy of the content.

33. The method of claim 22, wherein the digital signature of the obligor attests to the identity of the content.

34. The method of claim 22, wherein the digital signature of the obligor comprises a hash value encrypted using a key.

35. The method of claim 22, wherein the digital signature of the obligor uses public key infrastructure technology.

36. The method of claim 22, wherein the digital signature of the obligor comprises a time stamp.

37. The method of claim 22, wherein the signed content is stored on a trusted server.

38. The method of claim 22, wherein the electronic record is stored on a trusted server.

39. The method of claim 22, wherein the signed content is encrypted.

40. The method of claim 22, wherein the electronic record is encrypted.

41. A method of storing content relating to an obligation owed by an obligor, comprising the steps of:
binding the content describing the obligation under a digital signature of the obligor to form signed content;
placing the obligation in an assignment-pending status between initiating an assignment of the obligation and completing the assignment of the obligation.

42. The method of claim 41, further comprising the step of canceling a pending assignment if another assignment is initiated while the obligation is in the assignment-pending status.

43. The method of claim 41, further comprising the step of blocking another assignment if the other assignment is initiated while the obligation is in the assignment-pending status.

44. The method of claim 41, further comprising the step of notifying the assignor if another assignment is initiated while the obligation is in the assignment-pending status.

45. The method of claim 41, further comprising the step of canceling a pending assignment if the obligation is in the assignment-pending status beyond a given length of time.

46. A method of storing content relating to an obligation owed by an obligor, comprising the steps of:
binding the content describing the obligation under a digital signature of the obligor to form signed content;
receiving a digital signature of a secured party;
storing the digital signature with the content to indicate the security interest of the secured party in the obligation described by the content.

47. The method of claim 46, wherein the digital signature of the secured party is a digital signature of at least the content.

48. The method of claim 46, further comprising the step of:
preventing assignment of the obligation without authority from the secured party.

49. The method of claim 48, wherein the digital signature is a digital signature binding at least information indicating an identity of an owner of the obligation.

50. The method of claim 46, further comprising the step of:
placing the obligation in a grant-pending status between initiating of a grant of a security interest in the obligation and completing grant of the security interest in the obligation.

51. The method of claim 50, further comprising the step of canceling a pending grant of a security interest if another grant of a security interest is initiated while the obligation is in the grant-pending status.

52. The method of claim 50, further comprising the step of blocking another grant of a security interest if the other grant of a security interest is initiated while the obligation is in the grant-pending status.

53. The method of claim 50, further comprising the step of notifying an owner of the obligation if another grant of a security interest is initiated while the obligation is in the grant-pending status.

54. The method of claim 50, further comprising the step of canceling a pending grant of a security interest if the obligation is in the grant-pending status beyond a given length of time.

55. The method of claim 46, further comprising the steps of:
binding new content describing a new obligation from the obligor to the secured party under a digital signature of the obligor to form new signed content; and
storing the new signed content.

56. The method of claim 46, further comprising the step of:
maintaining a history of former secured parties that includes at least one secured party that previously had a security interest in the obligation.

57. A method of storing content relating to an obligation owed by an obligor, comprising the steps of:
binding the content describing the obligation under a digital signature of the obligor to form signed content, wherein the content is an amendment of a previous version of the content; and
maintaining a copy of the previous version of the content with the content stored.

58. The method of claim 57, further comprising the step of maintaining a list of all prior versions of the content.

59. The method of claim 58, wherein the list includes an owner identification for each of the prior versions of the content.

60. The method of claim 58, wherein the list includes an encryption key associated with each of the prior versions of the content.

61. A method, comprising the steps of:
within a trusted environment:
binding content describing an obligation under a digital signature of an obligor of the obligation; and
storing the bound content and obligor's signature at a trusted server.

62. A method, comprising the steps of:
within a trusted environment:
binding content describing an obligation under a digital signature of an obligee of the obligation; and
storing the bound content and obligee's signature at a trusted server.

63. A method, comprising the steps of:
storing in a memory of a computer a record of an obligation from an obligor to an obligee, the record being stored in a form indicating that ownership by the obligee is encumbered by a security interest in favor of a secured party, the record being stored under a protocol that ensures that any transfer of ownership of the record will be with the assent of the secured party.

64. A business method comprising the steps of:
forming a consortium of companies in a related market;
binding content describing an obligation in the related market under a digital signature of an obligor to form signed content;
binding an encryption key of an assignee of the obligation and a digital signature of an assignor of the signed content with a digital signature of the assignor to form an assignment component; and
binding the assignment component and the signed content with a digital signature of the assignee to form an electronic record.

65. A system for storing and binding content describing an obligation from an obligor to an obligee, comprising:
an access device;
a communications network coupled to the access device; and
a trusted server coupled to the communications network that:
store the content;
binds the content under a digital signature of the obligor;
binds the content under a digital signature of the obligee to form a record of the obligation;
binds the content, the digital signature of the obligor, and the digital signature of the obligee under a digital signature of the trusted server to form an authoritative copy of the record;
receives a digital signature of an assignor of the obligation that attests to release of the obligation by the assignor;
stores the digital signature of the assignor as part of the record;
receives a digital signature of an assignee of the obligation;
affixes the digital signature of the assignee to the record;
requires receipt of identity corresponding to the digital signature of the assignee to ensure that the assignee agrees to a transfer of the obligation;
indicates in the record that ownership of the obligation is encumbered by a security interest in favor of a secured party;
requires consent of the secured party before a transfer of the obligation; and
provides access over a communications network to the record.
